(19) United States
(12) Patent Application Publication
(10) Pub. No.: US 2016/0241841 A1
(43) Pub. Date: Aug. 18, 2016

(54) A STEREOSCOPIC ASSEMBLY AND METHOD FOR MANUFACTURING SAME

(71) Applicant: INUITIVE LTD., Ra'anana (IL)

(72) Inventor: Shai DOROT, Netanya (IL)

(21) Appl. No.: 15/027,045

(22) PCT Filed: Sep. 8, 2014
(86) PCT No.: PCT/IL2014/000045

§ 371 Date: Apr. 4, 2016

Related U.S. Application Data
(60) Provisional application No. 61/885,533, filed on Oct. 2, 2013.

(51) Int. Cl. H04N 13/02; G02B 7/04; G02B 7/00

(52) U.S. Cl. CPC H04N 13/0239; G02B 7/003; G02B 7/04

(57) ABSTRACT

A stereoscopic optical assembly comprising: a single unit mounting bar having a plurality of openings for receiving a plurality of image capturing optical elements; a plurality of image capturing devices mounted on the single unit mounting bar; wherein the plurality of openings are arranged to enable obtaining a stereoscopic image from the plurality of image capturing devices, and wherein the stereoscopic image is derived from images captured by each of the image capturing devices.

### TECHNICAL FIELD

The present disclosure generally relates to optical devices, and more particularly, to aligned stereoscopic assemblies.

### BACKGROUND

A stereoscopic camera arrangement is an element made of two camera units, assembled in a stereoscopic module. Stereoscopy (also referred to as “stereoscopics” or “3D imaging”) is a technique for creating or enhancing the illusion of depth in an image by means of stereopsis. In other words, it is the impression of depth that is perceived when a scene is viewed with both eyes by someone with normal binocular vision which is responsible for creating two slightly different images of the scene in the two eyes due to the eyes'camera's different locations.

Most stereoscopic methods present two offset images separately to the left and right image capturing means (the eyes of the viewer or cameras). These two-dimensional images are then combined to provide the perception of three dimensional depth. This technique is distinguished from 3D displays that display an image in three full dimensions, allowing the observer to increase information about the 3-dimensional objects being displayed by head and eye movements.

The stereoscopic alignment of the two camera units is a challenging task, due to optical constraints on the one hand, versus mechanical limitations on the other hand. In order to obtain satisfactory output from such an arrangement, the stereoscopic arrangement is required to be optically and mechanically aligned and calibrated to very high degrees of precision. However, the optical requirements impose quite severe mechanical limitations. Having a precise assembly dictates costly processes, which result in high price of stereoscopic elements.

Various attempts were made in the past to overcome the problems associated with the alignment of stereoscopic arrangements. However, the solutions proposed in these attempts suffer from the following drawbacks:
1. Active alignment is required in the process, in order to achieve a high degree of mutual alignment between the two cameras;
2. The need to implement a multi-step assembly process by which the camera modules are first assembled. Then, the stereo module is formed. For each step, high accuracy and very low tolerance of assembly must be followed.
3. Since the stereo alignment outcome of this process is unpredicted due to accumulative offsets imposed by the various assembly tasks, extensive post, assembly calibration steps are required.
4. Small footprint required by mobile services, resulting in a weak optic bench which affects the life time of the module.

A number of solutions were proposed in the art to overcome the problems associated with the alignment of stereoscopic arrangements. For example:

US 20090128621 describes a system that provides an automated stereoscopic alignment of images. The system provides automated stereoscopic alignment of images, such as, for example, two or more video streams. By having a computer that is programmed to automatically align the images in a post production process after the images are captured by a camera array. The computer may, alternatively, be programmed to automatically align the cameras by using motors associated with the camera array, simultaneously, while capturing the images.

US 20120200212 discloses a modular, self-contained optical box which has a back plate fixedly attached to a front wall. Optical sensors, such as cameras are fixedly attached to the front wall and the back plate. Distal, round ends of the optical sensors are captured by translation plates. Each translation plate is capable of moving the distal end of the optical element in two directions to or in a planar fashion to align the optical element to the optical box, or to adjust the line of sight of the optical sensors relative to the optical box, before securing the distal end of the optical element.

### SUMMARY OF THE DISCLOSURE

The disclosure may be summarized by referring to the appended claims.

It is an object of the present disclosure to provide a new optical module for mounting image capturing devices thereon, while reducing the cost involved and minimizing offsets/differences existing between different modules.

It is another object of the present disclosure to provide a method for manufacturing the new optical module while reducing the number of steps involved for obtaining a stereoscopically aligned assembly.

It is still another object of the present disclosure to provide a stereoscopically aligned assembly having enhanced reliability and robustness.

It is yet another object of the present disclosure is to provide an optical module which will reduce the calibration processes required while manufacturing each optical assembly.

Other objects of the present disclosure will become apparent from the following description.

According to one embodiment, there is provided stereoscopic optical assembly comprising:

a single unit mounting bar having a plurality of openings for receiving a plurality of image capturing optical elements;

a plurality of image capturing devices mounted on the single unit mounting bar;

wherein the plurality of openings are arranged to enable obtaining a stereoscopic image from the plurality of image capturing devices, and wherein the stereoscopic image is derived from images captured by each of the image capturing devices.

The term “stereoscopic” as used herein throughout the specification and claims, is used typically to denote a combination derived from two images each taken by a different image capturing means, which are combined to provide the perception of three dimensional depth. However, it should be understood that the scope of the present invention is not restricted to deriving a stereoscopic image from two sources, but also encompasses generating an image derived from three or more image capturing means.

The terms “image” or “image capturing device” as used herein throughout the specification and claims, are used to denote a visual perception being depicted or recorded by an artifact (the device), including but not limited to, a two dimensional picture, a video stream, a frame belonging to a video stream, and the like.

According to another embodiment the stereoscopic optical assembly is further characterized in that the plurality of openings are located so that they all share a common geometrical axis (a latitudinal or a longitudinal axis).

In accordance with another embodiment, the stereoscopic optical assembly is further characterized in that the plurality of openings comprises three openings arranged in a right angled triangle arrangement, so that each opening among these three openings, is located at different vertex of the triangle.

By yet another embodiment, the stereoscopic optical assembly is further characterized in that the at least two image capturing devices are aligned by aligning the optical axes of their respective lenses.

In accordance with another aspect there is provided a method for manufacturing a stereoscopic optical assembly which comprises the steps of:
providing a single unit mounting bar;
making a plurality of cavities (e.g. holes) in the single unit mounting bar, each configured for receiving an image capturing optical element, wherein the plurality of cavities are located so that they share a common axis;
heating the single unit mounting bar and inserting in each of the plurality of cavities, a barrel holding at least one component associated with an image capturing device (e.g. an adaptor connected to the image capturing device);
aligning an optical axis of the lens of each of the plurality of the image capturing devices by turning the lens barrel within the respective cavity, until the optical axis offset (e.g. caused by optic lens modules' misalignment) of the lens of each of the image capturing devices coincides with an axis that is at the same plane as the common axis, and is perpendicular to an axis of the respective image capturing device, which is not shared by the plurality of the image capturing devices; and
allowing the single unit mounting bar with the image capturing devices mounted thereon, to cool down.

By another embodiment, the step of alignment is carried out simultaneously for all of the plurality of the image capturing devices.

According to yet another embodiment, the method further comprises a step of carrying out a focal adjustment of the at least two image capturing optical elements following which the focus level of at least one of the at least two, image capturing optical elements is reduced in order to obtain an appropriate stereoscopic image from the at least two at least two image capturing optical elements. Since the focus level of each camera module is a crucial factor in carrying out the task of comparing two images for obtaining the stereoscopic image, the fact that the step of carrying out a focal adjustment is performed on the stereo bench (i.e. the mounting bar with the least two image capturing optical elements mounted thereon), enables to reduce the focus level of at least one of the least two image capturing optical elements (e.g. at least one of the cameras) and yet to obtain a proper match between images received from the two cameras, thereby simplifying post processing tasks.

According to another aspect there is provided system that comprises:
a display;
two gaze detection sensors operative to provide a stereoscopic image for determining a portion of the display to which a user's gaze is currently directed, wherein the two gaze detection sensors are mounted on a single unit mounting bar having a plurality of openings arranged to enable obtaining a stereoscopic image from the two gaze detection sensors, and wherein the stereoscopic image is derived from images captured by each of the two gaze detection sensors;
one or more processors operative to determine one or more portions of the display towards which the user's gaze was directed.

### BRIEF DESCRIPTION OF THE DRAWINGS

For a more complete understanding of the present invention, reference is now made to the following detailed description taken in conjunction with the accompanying drawing wherein:

FIGS. 1A and 1B—are schematic views of a monolithic single unit mounting bar construed in accordance with two embodiments of the present invention;

FIG. 2A—exemplifies a method for preparing a stereoscopic optical assembly in accordance with an embodiment of the present invention;

FIG. 2B—is a flow chart illustrating a method for preparing a stereoscopic optical assembly in accordance with an embodiment of the present invention; and

FIG. 3—is a schematic view of a stereoscopic optical assembly in accordance with an embodiment of the present invention.

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present invention by way of examples. It should be apparent, however, that the present invention may be practiced without these specific details.

According to one embodiment of the present invention there is provided a system which includes an aligned stereoscopic assembly used for generating aligned stereoscopic images, such as, for example, from two or more video streams.

A stereo camera is an element comprises two camera units, assembled in a stereoscopic setup. In order to provide good results, the stereoscopic assembly is required to be aligned and calibrated to a very high degree of precision, which in turn dictates costly processes, resulting in high priced stereo elements.

The system may include a camera array that has two or more cameras, such as, for example, video cameras for capturing two or more video streams of the target. Typically, the system further comprises a processor operative to merge the images in a post production process (i.e. after the images have been captured by the camera array).

It is, of course, generally known that stereoscopic video and/or films are created by videographing and/or filming a target with an array of cameras. For such an array of cameras, the cameras are fixed on amounting bar to hold the cameras in place relative to each other while filming the target. The solution provided by the present invention of the single unit mounting bar overcomes the typical prior art problem by which even when using a perfectly stable mounting bar (or a tripod) and taking precautions to physically align the cameras, still, the video streams captured by the array of cameras are usually not aligned. These video streams created by the array of cameras may be misaligned horizontally, vertically and/or rotationally with respect to each other.

One of the main advantages of the solution provided herein, is that it allows reducing the adverse effect of accumulating offsets generated along the prior art work flow, as the lens modules are assembled within the lens barrel, and the barrel is fixed onto the sensors substrate, followed by placing the digital Charged-Coupled Device (“CCD”) thereon. This advantage may be achieved by:
a. performing the alignment process simultaneously for both camera (image capturing device) modules;
b. using one accurate “pick and place” procedure when placing the sensor at its place;
c. minimizing the offsets existing between the lens optic axis and the sensors' centerline;
d. essentially eliminating focus mismatch and optical offsets along the Y axis.

According to an embodiment of the invention, there is provided an optical bench (a single unit mounting bar) designs to hold two (or more) imaging sensor aligned and calibrated for stereoscopic imaging application, which is configured to hold both their respective image sensor lens body rather than the image sensor substrate or body. This principal provides the advantages:
a. The optical bench may be thicker and robust as compared with other solutions known in the art.
b. It enables building in advance the optical axis of each of the two imaging sensor parallel to each other or at any required squint angle skewed with respect to the mounting bar.
c. It enables the optical axis of each lens to be placed in a predefined position and direction.

The sensing array of each imaging sensor is assembled onto the optical bench relative to its corresponding lens while performing 6DOF alignment of its position relative to the optical axis of the lens. The assembly process may comprise the following steps:
a. Assemble the sensing array on a substrate that contains the electrical interfaces and the mechanical interfaces;
b. Position the assembly at its location where 5 of the 6 DOF may be aligned by mechanical means, for example:
   i. Matching the surface of the sensor assembly substrate with an appropriate surface on the optical bench—aligning 2 tilting angles. The sensing array would be perpendicular to the optical axis;
   ii. Matching the sides of the substrate with an appropriate mechanical flanges onto the optical bench—aligning lateral position (X,Y) relative to the optical axis and aligning the roll rotation of the imaging sensors with each other;
c. It may be preferred to adjust the position of the sensing array along the z direction in order to perform the required focusing. There may be few options for obtaining this result. For example:
   i. The optical lens production and assembly are accurate enough to perform the focusing only by mechanical means;
   ii. The back focal length (BFL) of each lens is measured and the sensing array is positioned at the required position, by choosing the appropriate spacer that matches the measured BFL;
   iii. The lens is placed at its cavity while performing focusing procedure relative to the optical bench matting surface (bi). Alternatively, the lens is inserted at its cavity in the optical bench according to the measured BFL;
   iv. Using autofocus lenses that can be automatically focused, after operating the camera.

All other components that are needed to operate the stereo module, such as processing chip, lighting elements etc., are assembled thereafter, followed by performing a calibration process in order to calibrate the stereoscopic module in order to provide a 3D stereo images and 3D depth image and/or other applications.

It should be noted that the order for carrying out the steps described above should not be considered as a limiting order for carrying out the present invention, and the steps may be carried out according to any other applicable order.

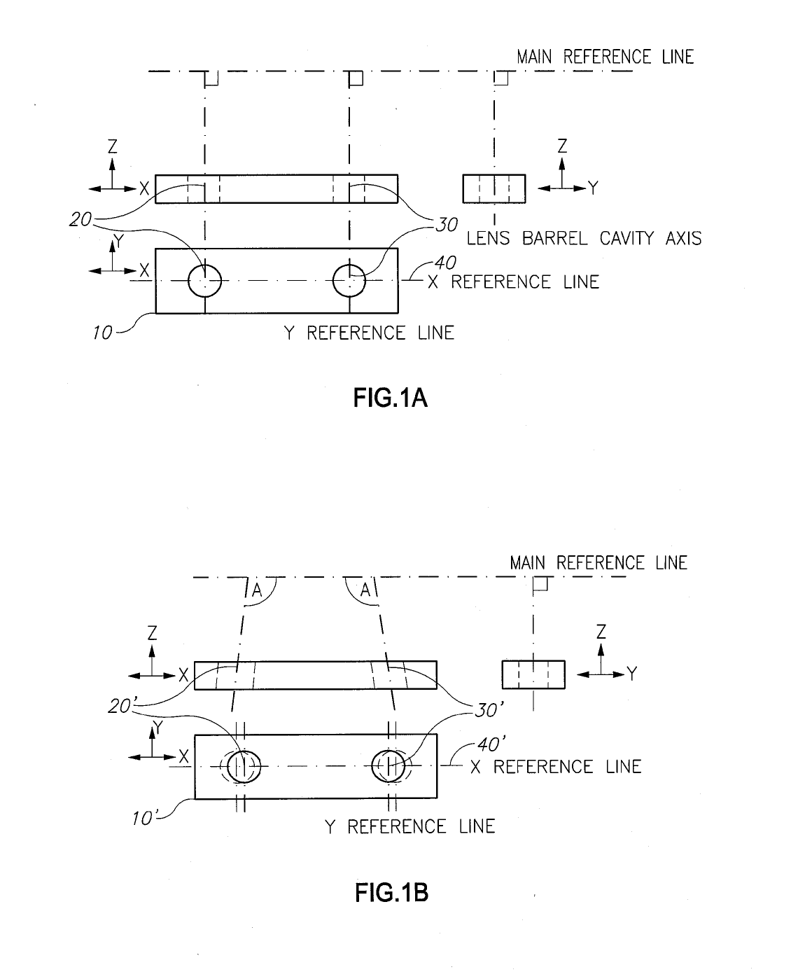

FIG. 1A and FIG. 1B illustrate two different examples of embodiments of the present invention, which demonstrates a monolithic single unit mounting bar 10 and 10′, each comprising two cavities, 20 and 30 and 20′ and 30′, respectively, and each having an opening adapted to receive an adaptor of a camera to be mounted thereat (e.g. a barrel of the camera's lens). The two openings of cavities 20 and 30 in FIG. 1A, and the two openings of cavities 20′ and 30′ in FIG. 1B are arranged in a way that ensures that when the two cameras are mounted onto mounting bar 10 and 10′, respectively, one is able to obtain a stereoscopic image by combining the images/video streams retrieved from each of two respective cameras. While the central axes of the cylindrical holes illustrated in FIG. 1A are essentially perpendicular to the mounting bar surface, those of FIG. 1B are skewed with respect to the mounting bar surface. The skew angle of both cavities (20) and (30) is designated in this figure as A.

Also, as may be seen in FIG. 1A for example, the openings of the two cavities are located so that they share a common latitudinal axis 40.

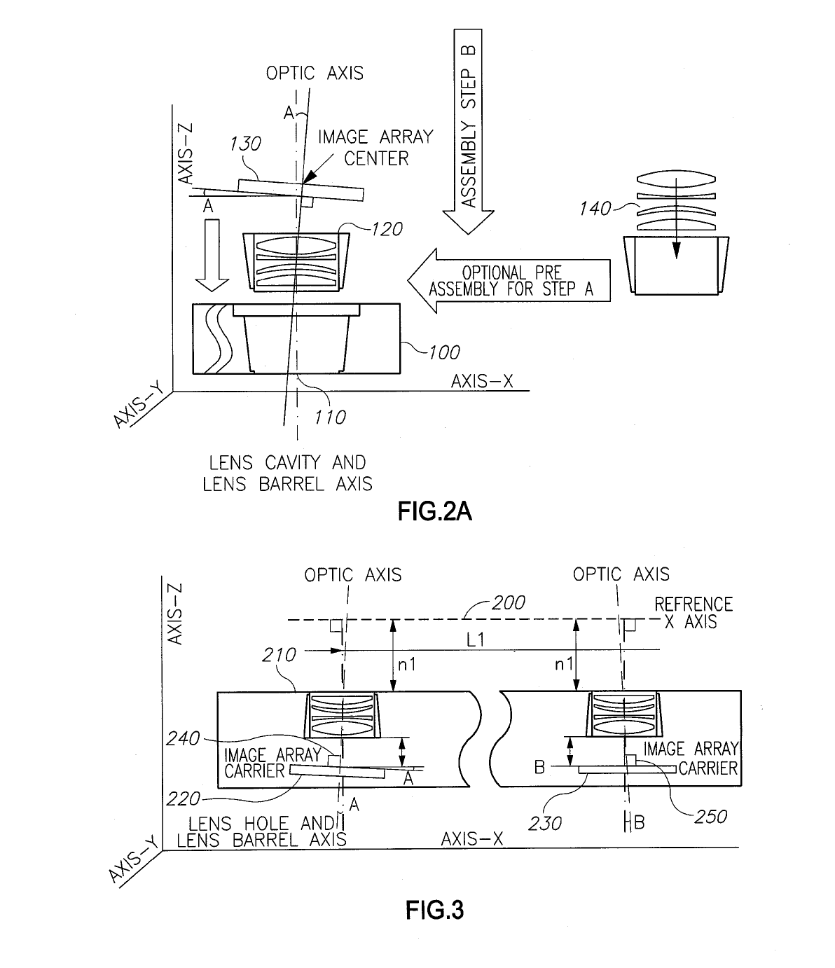

FIG. 2A exemplifies a method for preparing stereoscopic assembly in accordance with an embodiment of the present invention. A partial view of mounting bar 100 showing one cavity is presented in this figure (wherein the process may be carried out while using other of the plurality of cavities). In the first assembly phase, lens barrel 120 is inserted in cavity 110 and in the second assembly phase the image sensing chip 130 is fixed to the back end of the monolithic bench.

In addition, an optional step is illustrated in FIG. 2A whereby the lens modules 140 are placed within the lens barrel prior to inserting lens barrel 120 in cavity 110.

FIG. 2B illustrates a flow chart of a method for preparing a stereoscopic assembly in accordance with an embodiment of the present invention. First, a single unit mounting bar is provided (step 200). Then, a plurality of cavities is made in the single unit mounting bar (step 210), each configured for receiving an image capturing optical element to be mounted thereat. All the cavities are located so that they share a common geometrical axis. The cavities are made by using any appropriate CNC/molding method known in the art per se to prepare the stereoscopic bench (the mounting bar) having the two aligned cavities, and in addition the appropriate openings to accommodate other parts such as a processing chip, a sensor chip, IR leds, and the like. As mentioned before, the centers of the above two cavities' openings are located along the same X axis, having a distance therebetween which corresponds to the required field of view, while maintaining the minimal offset in their positions along their Z and Y axes.

Next, the mounting bar is heated (step 220) to increase the opening sizes of the cavities, and consequently to ease on performing the next step, i.e. the insertion a lens barrel in each of the cavities, where the lens barrel holds at least one component associated with an image capturing device (step 230).

Then, the offset of the optical axis of the lens of each of the two image capturing devices are aligned (step 240), preferably, by turning the barrel within the respective cavity until the offset of the optical axis of the lens of each of the image capturing devices coincides with the X axis of the mounting bar, which is at the same plane as the common latitudinal axis and is perpendicular to both their non-common axes.

As explained above, the heating process is performed in order to allow easy insertion and turning of the lens barrel and then locking it at its place within the cavity. However, in an alternative, as may be seen for example in FIG. 2A, a different step may be carried out to ensure the fixing of the lens barrel at its appropriate position. According to this alternative, the cavity shape is a cone-like shape that matches a cone shaped lens barrel, and with the use of appropriate adhesive, the results of locking the lens barrel in its right position may also be achieved.

Optionally, during the step of the optical alignment of the image capturing devices, calibration related data may also be generated by the image capturing devices, and retrieved therefrom for additional stereophonic post processing tasks.

Finally, the mounting bar having the lens barrels (and optionally other elements that may also be inserted at the cavities designed to hold them, is cooled down (step 250). This latter step could for example be carried out actively or passively, in which case a mechanical stopper may further be used to ensure that the lens barrels are properly mounted onto the mounting bar. Carrying out this step ensures at the end of the process, that a tight contact is obtained between the inserted lens barrel and the cavity walls.

Finally, the image capturing devices are placed in accordance with their respective lens optical axis (step 260).

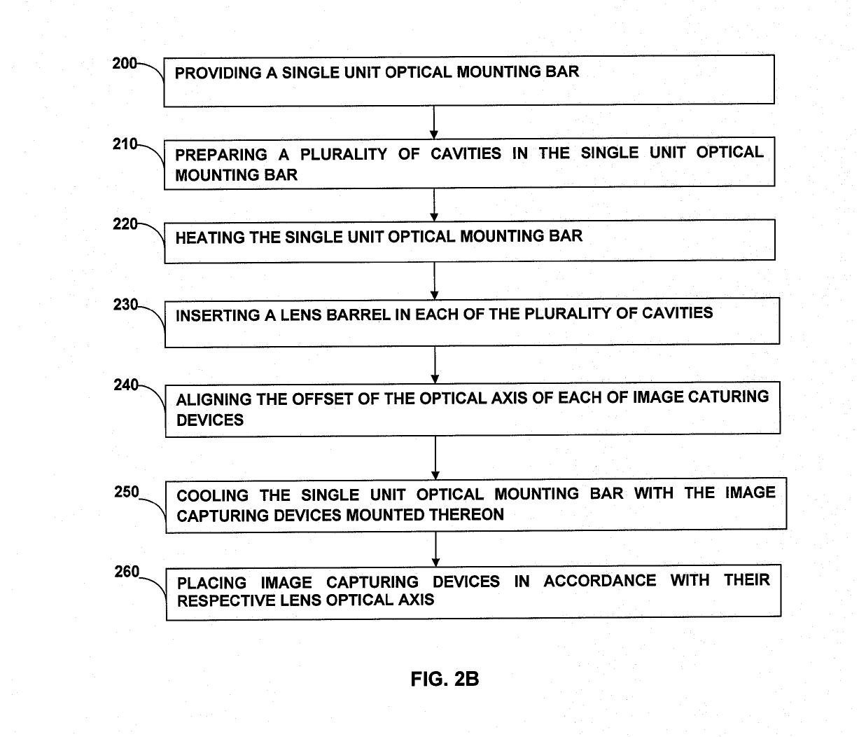

FIG. 3 illustrates a schematic view exemplifying a stereoscopic optical assembly 200 in accordance with an embodiment of the present invention. The assembly comprises a mounting bar 210 such as the one described above in connection with FIGS. 1A and 1B, two gaze detection sensors 220 and 230 comprising image arrays mounted on the mounting bar which are operative to capture images for generating a stereoscopic image of a user watching a display, are placed at the back of the lens barrels, preferably they are placed in alignment with their respective optical axes 240 and 250, at the center of the corresponding image arrays (220 and 230). In this example, as may be seen in FIG. 3, the inclination of the two image arrays may be different due to optical axes and cavity offset that exist between the two devices. The effect of this inclination is compensated by proper positioning of the sensor prior to fixing it to the bench, thereby enabling to obtain the stereoscopic image at the required quality.

By implementing the solution provided by the present invention of a monolithic optical bench approach, meaningful advantages are achieved both in stereophonic image quality and in savings of time and cost required for the assembly, as there is practically one precise and relatively simple assembly process which is now needed to obtain a fully aligned and focused stereoscopic module.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. For example, preparing the mounting bar may be carried out without going through the heating step, the cavities may be in a cone shape or other applicable shape, a structure that contains three sensors on may be vertexes of a right angle triangle, or any other applicable structure. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1-8. (canceled)

9. A method for assembling a stereoscopic electro-optical assembly, comprising the steps of:
providing a single unit mounting bar that comprises a plurality of openings, said openings sharing one or more common geometrical axes;
inserting a plurality of optical image capturing elements into respective openings from among said plurality of openings and mechanically aligning at least one of their optical axes relative to one of the common geometrical axes;
fixedly attaching each of the plurality of optical image capturing elements to said mounting bar;
aligning each of the at least two image capturing devices to be positioned orthogonal to an optic axis of its respective optical image capturing element associated therewith, and to be positioned so that they are in alignment with one of said common geometrical axes;
adjusting the distance of each of the image capturing devices from its respective optical image capturing element, while maintaining current alignment settings; and
fixedly attaching each of the image capturing devices, thereby obtaining a mechanically aligned stereoscopic electro-optical assembly.

10. The method of claim 9, further comprising collecting data associated with offsets in positions of the optical image capturing elements from their respective image capturing devices and between at least two of the image capturing devices as have been determined while carrying out said method, thereby enabling to determine aligned position for each of the at least two image capturing devices relative to each other.

11. The method according to claim 9, wherein said method is configured to enable generating 3D depth images by said stereoscopic electro-optical assembly.

12. A stereoscopic electro-optical assembly assembled by implementing the method of claim 9

13. A stereoscopic electro-optical assembly, wherein the stereoscopic electro-optical assembly is configured to hold data associated with offsets in positions of the optical image capturing elements from their respective image capturing devices and between at least two of the image capturing devices that have been determined while carrying out said method of claim 9, to enable determining aligned position for each of the at least two image capturing devices relative to each other.
